(19) United States
(12) Patent Application Publication
(10) Pub. No.: US 2012/0057274 A1
(43) Pub. Date: Mar. 8, 2012

(54) Lithium ion capacitor

(75) Inventors: Hak Kwan Kim, Hanam-si (KR); Bae Kyun Kim, Seongnam-si (KR); Dong Hyeok Choi, Suwon-si (KR); Hyun Chul Jung, Yongin-si (KR)

(73) Assignee: SAMSUNG ELECTRO-MECHANICS CO., LTD., Suwon (KR)

(21) Appl. No.: 13/137,542

(22) Filed: Aug. 24, 2011

(30) Foreign Application Priority Data
Aug. 31, 2010 (KR) 10-2010-0084814

(51) Int. Cl. H01G 9/155

(52) U.S. Cl. 361/502

(57) ABSTRACT

Provided is a lithium ion capacitor. The lithium ion capacitor includes an electrode cell provided with cathodes and anodes alternately disposed with the separators interposed therebetween, a first electrolyte in a phase of gel arranged on at least one surface of the anode and a second electrolyte in a phase of liquid immerged into the electrode cell.

### CROSS-REFERENCE TO RELATED APPLICATIONS

This application claims the benefit of Korean Patent Application No. 10-2010-0084814 filed with the Korea Intellectual Property Office on Aug. 31, 2010, the disclosure of which is incorporated herein by reference.

### BACKGROUND OF THE INVENTION

1. Field of the Invention

The present invention relates to a lithium ion capacitor, and more particularly, to a lithium ion capacitor including a gel phase electrolyte for preventing dendrite from growing from an anode and a liquid phase electrolyte for assisting the gel phase electrolyte.

2. Description of the Related Art

In general, electrochemical energy storage devices are core parts of finished products, which are essentially used in all mobile information communication devices and electronic devices. In addition, the electrochemical energy storage devices will be used as high quality energy sources in new and renewable energy fields that can be applied to future electric vehicles and mobile electronic devices.

The electrochemical energy storage devices, typically, a lithium ion battery and an electrochemical capacitor, use an electrochemical theory.

Here, the lithium ion battery is an energy device that can be repeatedly charged and discharged using lithium ions, which has been researched as an important power source having higher energy density per unit weight or unit volume than the electrochemical capacitor. However, the lithium ion battery is difficult to be commercialized due to low stability, short use time, long charge time, and small output density.

In recent times, since the electrochemical capacitor has lower energy density but better instant output and longer lifespan than the lithium ion battery, the electrochemical capacitor is being rapidly risen as a new alternative that can substitute for the lithium ion battery.

In particular, a lithium ion capacitor among the electrochemical capacitors can increase energy density without reduction in output in comparison with other electrochemical capacitors, attracting many attentions.

The lithium ion capacitor includes a collector as an anode and active material layers arranged at both sides of the collector. Here, the active material layers can secure high energy density by including graphite capable of doping and dedoping the lithium ion reversibly.

However, if the active material layer including the graphite is used as the anode, the stability of the lithium ion capacitor is deteriorated, since the active material layer can be shrunk or expanded due to the doping and dedoping of the lithium ion during the charging and discharging.

Accordingly, a lot of attempts have been tried to use the lithium metal as an anode. Here, since the lithium metal has a high capacity in comparison with graphite and small density among metals as well as the deformation such as shrink or expansion is not caused during the charging and discharging, the stability of the lithium ion capacitor can be secured.

However, since the dendrite lithium is grown due to the non-uniform reaction at the surface of anode during the repeatable charging and discharging of the lithium ion capacitor, there are problems that the lithium ion capacitor is short therein and the stability thereof is deteriorated.

### SUMMARY OF THE INVENTION

The present invention has been invented in order to overcome the above-described problems and it is, therefore, an object of the present invention to provide a lithium ion capacitor including a gel phase electrolyte for preventing dendrite from growing from an anode and a liquid phase electrolyte for assisting the gel phase electrolyte.

In accordance with one aspect of the present invention to achieve the object, there is provided a lithium ion capacitor comprising: an electrode cell including cathodes and anodes alternately disposed with the separators interposed therebetween; a first electrolyte in a phase of gel arranged on at least one surface of the anode; and a second electrolyte in a phase of liquid immerged into the electrode cell.

Here, the first electrolyte includes at least one among LiPON, L_{a2/3-x}Li₃ₓTiO₃(here, 0<x<0.17), LiM₂(PO₄)₃(here, M is quadrivalent positive ions) and Li₂₊₂Zn₁₋ₓGeO₄ (here, 0<x<0.17).

In addition, the second electrolyte includes lithium salt and carbonate group solvent.

In addition, the lithium salt includes at least one among LiPF₆, LiBF₄ and LiClO₄.

In addition, the carbonate group solvent includes at least one or two mixed solvent among propylene carbonate, ethylene carbonate, diethyl carbonate, dimethyl carbonate and ethyl methyl carbonate.

In addition, the anode is made of any one among the lithium metal or the lithium alloy.

In addition, the cathode includes a cathode collector and a cathode active material layer arranged on at least one surface of the cathode collector.

In addition, the cathode active material layer includes charcoal.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a lithium ion capacitor in accordance with a first exemplary embodiment of the present invention;

FIG. 2 is an assembled perspective view of the lithium ion capacitor shown in FIG. 1; and

FIG. 3 is a cross-sectional view of an electrode cell of FIG. 1.

### DETAILED DESCRIPTION OF THE PREFERABLE EMBODIMENTS

Hereinafter, embodiments of the present invention for a lithium ion capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

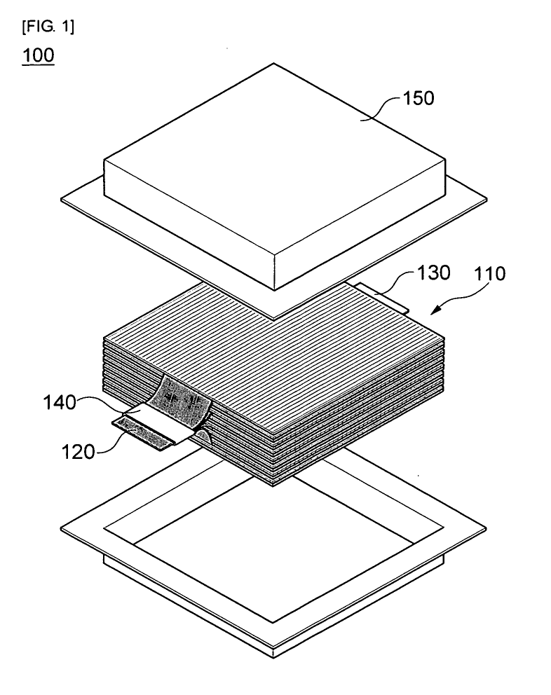

FIG. 1 is an exploded perspective view of a lithium ion capacitor in accordance with a first exemplary embodiment of the present invention.

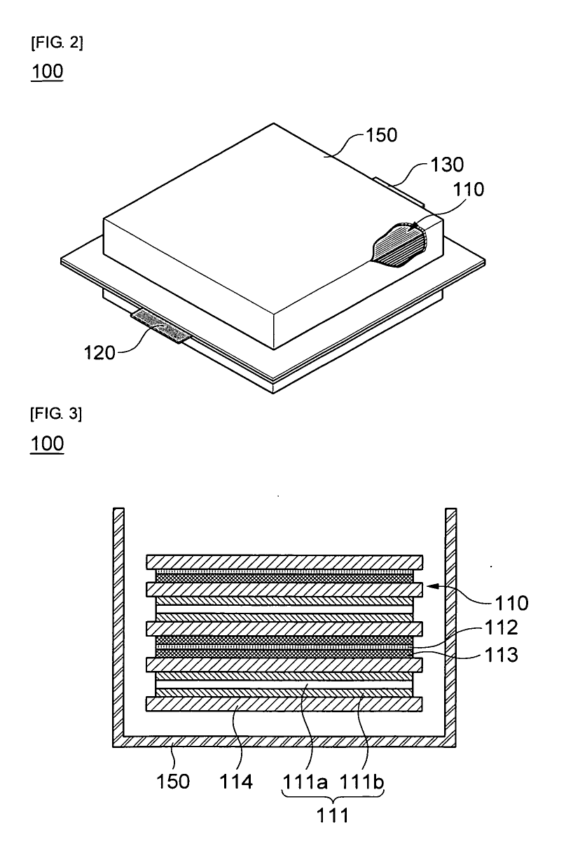

FIG. 2 is an assembled perspective view of the lithium ion capacitor shown in FIG. 1.

FIG. 3 is a cross-sectional view of an electrode cell of FIG. 1.

Referring to FIGS. 1 to 3, a lithium ion capacitor 100 in accordance with a first exemplary embodiment of the present invention may include an electrode cell 110 and a housing 150 for receiving and sealing the electrode cell 110.

Here, the lithium ion capacitor 100 may be referred to as a supercapacitor, an ultracapacitor, or the like.

The electrode cell 110 may include cathodes 111 and anodes 112, which are alternately disposed with separators 113 interposed therebetween. At this time, the cathodes 111 and the anodes 112 may partially overlap each other. Here, in the electrochemical capacitor, i.e., the lithium ion capacitor, the cathode 111 may be referred to as a positive electrode. In addition, the anode 112 may be referred to as a negative electrode.

Since the anode 112 may include at least one among lithium metal or lithium alloy having the theoretical capacity of ten times in comparison with the conventional graphite, the energy density of the lithium ion capacitor 100 can be improved in comparison with a case that the anode 112 is made of the graphite. Also, as the lithium metal or the lithium alloy has a small density in comparison with the other metals, the weight of the lithium ion capacitor 100 can be reduced.

At this time, when the anode 112 is made of the lithium or the lithium metal, the lithium dendrite is grown from the surface of the anode 112, in this result, it penetrates the separator 114 to thereby be contact with the cathode 111. That is, if the anode 112 is made of the lithium or the lithium alloy, the cathode 111 and the anode 112 may be electrically shorten due to the growth of the lithium dendrite.

Accordingly, a first electrolyte 113 may be arranged on the surface of the anode 112, i.e., one surface opposing to the cathode 111. At this time, as the first electrolyte 113 is formed in a phase of gel, the growth of the lithium dendrite can be suppressed at the surface of the anode 112.

And also, the first electrolyte 113 can include lithium salt in order to smoothly perform the movement of the lithium ions between the anode 112 and the cathode 111. The examples of material for forming the first electrolyte 113 of the gel phase can include at least one among LiPON(Lithium phosphorus oxynitride), L_{a2/3-x}Li₃ₓTiO₃ (here, 0<x<0.17), LiM₂(PO₄)₃(here, M is quadrivalent positive ions) and Li₂₊₂ₓZn₁₋ₓGeO₄(here, 0<x<0.17). Here, the examples of quadrivalent positive ions may be any one among Si, Ge, Ti and Sn.

Accordingly, as the first electrolyte 113 in the phase of gel is provided on the surface of the anode 112, the stability of the lithium ion capacitor 100 can be secured by preventing the dendrite from growing at the surface of the anode 112. And also, the ion conductivity can be increased by including the lithium salt into the first electrolyte 113 in the phase of gel.

After the electrolyte powder is formed by an LFZ(laser floating zone) method at first in order to form the first electrolyte 113, it can be formed by coating the slurry, which is manufactured by mixing the electrolyte powder and non-aqueous solvents, on the anode 112. The first electrolyte 113 can be formed by an evaporation method as another formation method.

Here, as the first electrolyte 113 has the shape of gel phase, the high power density of the lithium ion capacitor 100 can be deteriorated since the deformation of the first electrolyte 113 can be generated by the heat generation due to the high current in the high power application fields.

At this time, the lithium ion capacitor 100 can include a second electrolyte for aiding the first electrolyte 113. The second electrolyte may be a liquid phase to accumulate charges by an electrostatic mechanism. Accordingly, the lithium ion capacitor 100 can increase the high power density by implementing the movement of lithium ions through the second electrolyte in the application fields of high power.

At this time, the second electrolyte may be immerged into the electrode cell 110, particularly into the separator 114 and a cathode active material layer 111b described hereafter.

Accordingly, the lithium ion capacitor 100 can use the lithium metal or the lithium alloy as the anode 112 by preventing the lithium dendrite from growing through the first electrolyte 113 and can play a role of improving the high power density vulnerable to the first electrolyte 113 through the second electrolyte. That is, the lithium ion capacitor 100 can satisfy the high energy density, the high power, reliability or the like at the same time in comparison with a case of including the conventional single electrolyte, as it includes the first and the second electrolytes.

The second electrolyte can include the lithium salt and the solvent. Here, the examples of the lithium salt are among LiPF6, LiBF4 and LiClO4 or the like. Here, the lithium salt can play of a role of a supplying source of the lithium ions doped during charging the lithium ion capacitor 100. And also, the solvent may be at least one or two mixed solvent among propylene carbonate, ethylene carbonate, diethyl carbonate, dimethyl carbonate and ethyl methyl carbonate as a carbonate based solvent capable of stably keeping the lithium ions without generating electrolysis in the high voltage.

In addition, the anode 112 can include an anode terminal 130 to be connected to an external power. The anode terminal 130 can be extended from the anode. Here, as the anode is stacked by a plurality of numbers, since the anode terminal 130 may be stacked by a plurality of numbers, the stacked anode terminal 130 is unified by an ultrasonic bonding in order to be easily contact with the external power. In addition, the anode terminal 130 can be connected to an external terminal by bonding or welding by being provided with an additional external terminal.

The cathode 111 can include an anode collector 111a and a cathode active material layer 111 b arranged at least one surface of the cathode collector 111a.

Here, the cathode collector 111a can be formed of metal, e.g., any one among aluminum, stainless, copper, nickel, titanium, tantalum and niobium or an alloy thereof.

In addition, the cathode active material layer 111b may include a carbon material, i.e., activated carbon, to which ions can be reversibly doped and undoped. Further, the cathode active material layer 111b may further include a binder. Here, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on. Further, the cathode active material layer 111b may further include a conductive material, for example, carbon black, solvent, and so on.

However, in this embodiment of the present invention, the material of the cathode active material layer 111b is not limited thereto.

Here, the cathode 111 may include a cathode terminal 120 to be connected to an external power source. The cathode terminal 120 may be formed by bonding a separate terminal thereto, or may extend from the cathode current collector 111a of the cathode 111.

In addition, the cathode terminal 120 and the anode terminal 130 may include insulating members 140 installed at portions of upper and lower parts thereof, respectively. The insulating members 140 may function to secure insulation between the cathode terminal 120, the anode terminal 130 and the housing 150, which is to be described.

The separator 114 may function to electrically separate the cathode 111 and the anode 112 from each other. While the separator 114 may be formed of paper or non-woven fabric, kinds of the separator in the embodiment of the present invention is not limited thereto.

While the electrode cell 110 of this embodiment of the present invention has been shown and described as being formed in a pouch type, the electrode cell 110 is not limited thereto but may be formed in a wound type in which the cathode 111, the anode 112 and the separator 114 are wound in a roll shape.

The electrode cell 110 immersed in the electrolyte can be sealed with the housing 150. Here, while the housing 150 may be formed by hot-melting two sheets of laminated films, the housing 150 of the embodiment of the present invention is not limited thereto but may be formed of a metal can.

Therefore, similar to the embodiments of the present invention, by forming the electrolyte in the phase of gel on at least one surface of the anode, the lithium ion capacitor can secure the stability by preventing the dendrite from growing from the anode.

And also, the lithium ion capacitor in accordance with the embodiments of the present invention can reduce the energy density and weight by preventing the dendrite of the anode from growing, as the lithium metal can be used as the anode.

And also, the lithium ion capacitor in accordance with the embodiments of the present invention can overcome the limitation of the high power density by including the liquid phase electrolyte for aiding the gel phase electrolyte.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A lithium ion capacitor comprising:
an electrode cell including cathodes and anodes alternately disposed with the separators interposed therebetween;
a first electrolyte in a phase of gel arranged on at least one surface of the anode; and
a second electrolyte in a phase of liquid immerged into the electrode cell.

2. The lithium ion capacitor according to claim 1, wherein the first electrolyte includes at least one among LiPON, L_{a2/3-x}Li₃ₓTiO₃ (here, 0<x<0.17), LiM₂(PO₄)₃(here, M is quadrivalent positive ions) and Li₂₊₂ₓZn₁₋ₓGeO₄ (here, 0<x<0.17).

3. The lithium ion capacitor according to claim 1, wherein the second electrolyte includes lithium salt and carbonate group solvent.

4. The lithium ion capacitor according to claim 3, wherein the lithium salt includes at least one among LiPF₆, LiBF₄ and LiClO₄.

5. The lithium ion capacitor according to claim 3, wherein the carbonate group solvent includes at least one or two mixed solvent among propylene carbonate, ethylene carbonate, diethyl carbonate, dimethyl carbonate and ethyl methyl carbonate.

6. The lithium ion capacitor according to claim 1, wherein the anode is made of any one among the lithium metal or the lithium alloy.

7. The lithium ion capacitor according to claim 1, wherein the cathode includes a cathode collector and a cathode active material layer arranged on at least one surface of the cathode collector.

8. The lithium ion capacitor according to claim 7, wherein the cathode active material layer includes charcoal.
